(19) United States
(12) Patent Application Publication
(10) Pub. No.: US 2024/0312256 A1
(43) Pub. Date: Sep. 19, 2024

(54) METHODS AND SYSTEMS FOR PRE-PROCESSING SIGNATURE DATA

(71) Applicant: STATE FARM MUTUAL AUTOMOBILE INSURANCE COMPANY, Bloomington, IL (US)

(72) Inventors: Matt Crowe, Garland, TX (US); Salomon Kabongo, Bloomington, IL (US); Anjie Spreen, Hewitt, TX (US); Kara Reed, Lewisville, TX (US)

(21) Appl. No.: 18/196,179

(22) Filed: May 11, 2023

Related U.S. Application Data
(60) Provisional application No. 63/452,639, filed on Mar. 16, 2023.

(51) Int. Cl. G06V 40/30; G06T 3/60; G06T 7/30

(52) U.S. Cl. CPC G06V 40/33; G06T 3/608; G06T 7/30; G06T 2207/20081; G06T 2210/12

(57) ABSTRACT

The following generally relates to pre-processing signature data. In some examples, the extracted signature data may be used to train a signature classification model configured to identify a signature type for an input signature. As part of the pre-processing, the techniques disclosed herein relate to extracting the signature data from a corpus of signed documents. For example, techniques disclosed herein may use anchor points to define a boundary box. Additionally, the pre-processing may include aligning the image data of the signatures, for example, by correcting a skew. The extracted and aligned signatures may be used to train the signature classification model.

### CROSS-REFERENCE TO RELATED APPLICATIONS

This application claims priority to and the benefit of the filing date of provisional U.S. Patent Application No. 63/413,490 entitled “Methods and Systems for Pre-Processing Signature Data,” filed on Mar. 16, 2023, the entire contents of which are hereby expressly incorporated herein by reference.

### FIELD OF THE INVENTION

The present disclosure generally relates to pre-processing signature data, and, more particularly, improving uniformity of signature data used to train a classification model.

### BACKGROUND

In several contexts, it is useful to be able to identify a signature type (e.g., handwritten, typed, wet-ink, signature pad, digitally applied by a trusted authenticator (such as DocuSign or Adobe), and so on). For example, many types of official forms have specific signature type requirements. If a signature applied to the form is not of the specified signature type, a processor of the form may reject the form as lacking a required signature.

To facilitate the signature type detection, companies may implement image classification techniques that automatically attempt to identify a signature type for detected signatures. For example, the companies may train an image classifier configured to apply a label to an input signature. One common source of training data is historical documents that include signatures that have been accepted or rejected using conventional signature analysis techniques.

According to certain aspects, features that indicate signature type may include line width, uniformity, and/or other features of the signature. Accordingly, if the historical documents are included in the corpus in an inconsistent manner and/or if different signature extraction techniques are applied, these features may manifest inconsistently, resulting in a signature that exhibits features of an incorrect signature type when analyzed by a signature type classifier. As a result, a classifier trained on the extracted signature data may be less accurate and lead to incorrect acceptance decisions for submitted form documents.

The conventional signature analysis techniques may include additional ineffectiveness, inefficiencies, encumbrances, and/or other drawbacks.

### SUMMARY

The present embodiments may relate to, inter alia, systems and methods for pre-processing signature data to improve the uniformity of the training set. As a result, the classifiers trained using the improved pre-processing techniques may more accurately classify signature types on submitted documents.

In one aspect, the systems and methods may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another.

In one aspect, a computer-implemented method for pre-processing signature data may be provided. The method may include (1) accessing, via one or more processors, a corpus of signed documents; (2) identifying a portion of image data in a signed document that represents a signature; (3) processing, via the one or more processors, the identified signatures to align the corresponding image data; (4) extracting, via the one or more processors, the aligned signatures; and (5) training, via the one or more processors, a signature type classifier using the aligned signatures. The method may include additional, fewer, or alternate actions, including those discussed elsewhere herein.

In another aspect, a computer system for pre-processing signature data may be provided. The computer system may include (i) one or more processors; and (ii) one or more non-transitory memories storing processor-executable instructions. The instructions, when executed by the one or more processors, may cause the system to (1) access a corpus of signed documents; (2) identify a portion of image data in a signed document that represents a signature; (3) process the identified signatures to align the corresponding image data; (4) extract the aligned signatures; and (5) train a signature type classifier using the extracted signatures. The system may perform additional, less, or alternate functionality, including that discussed elsewhere herein.

In yet another aspect, a non-transitory computer readable storage medium storing computer-executable instructions may be provided. The instructions, when executed by one or more processors, may cause the one or more processors to (1) access a corpus of signed documents; (2) identify a portion of image data in a signed document that represents a signature; (3) process the identified signatures to align the corresponding image data; (4) extract the aligned signatures; and (5) train a signature type classifier using the extracted signatures. The instructions may cause the processors to perform additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 shows an exemplary form analysis computing platform.

FIGS. 2A-2C illustrate an exemplary process for extracting a signature from a form document using anchor points.

FIG. 3A illustrates an example process for extracting a signature from a form document using a text extraction library.

FIG. 3B illustrates an example process for extracting a signature using a combination of anchor points and a text extraction library.

FIG. 4 illustrates an exemplary technique for determining skew in a form document.

FIG. 5 illustrates a block diagram of an exemplary computer-implemented method for pre-processing signature data, in accordance with embodiments disclosed herein.

### DETAILED DESCRIPTION

The systems and methods disclosed herein generally relate to, inter alia, training and machine learning techniques (such as image classification) to determine a signature type of a signature included in a form document. As it is generally used herein, the term “form document” refers to a standardized document that is submitted for acceptance by a submitter. For example, the standardized document may be an insurance application form, a title transfer form, a governmental and/or regulatory form document, and/or other types of standardized documents. Additionally, as it is generally used herein, the term “form document” may also refer to a set of image data representative of the form document (e.g., a scanned copy of the form document, an image of the form document, an electronically generated and/or submitted form document, and so on).

It should be appreciated that while the term “form document” is generally used herein, the signature extraction and/or pre-processing techniques may be applied to other types of documents that include signatures. Additionally, while the term “signature” is generally used herein, unless expressly indicated otherwise, the term “signature” encompasses initials applied to form documents.

According to certain aspects, there are various reasons to train a signature type classifier. For example, a form document may be deemed unacceptable if the wrong type of signature is used (e.g., a wet-ink vs. Adobe-inserted). In this example, a signature type classifier may be applied to classify an extracted signature. The signature type classification data may then be input into a set of acceptability rules to determine whether or not to accept the form document. If the form document includes multiple signatures, the system may extract each detected signature to determine compliance with the set of acceptability rules. As a result, the process for determining form acceptability may be automated.

To be able to deploy these automated tools, the signature type classifier may first be trained to detect the signature types. Typically, the training process may be performed with training data. A voluminous source of training data may be past examples of historical signed documents that have been manually analyzed for acceptability. As a result, the training data may include both images of example signatures and their manually assigned signature type. In some embodiments, the signature type may be inferred from the acceptability decision. It should be appreciated that in some embodiments that rely upon historical form documents as training data, personally identifiable information may be anonymized and/or scrubbed before the corresponding document is included in the training set.

According to certain aspects, the training data may be used to train a signature type classification model. In some embodiments, the signature type classification model may include a neural network, such as a convolutional neural network (CNN) model. For example, the CNN may be trained on a set of labeled historical data to produce a classification decision as to a signature type (e.g., handwritten wet-ink, handwritten e-signature, typed signature, stamped signature, DocuSign signature, etc.). In some embodiments, the signature type classification model may include component models configured to produce a binary classification with respect to whether or not a signature is a particular signature type. In other embodiments, the signature type classification model is able to classify the signature type without the component models for each signature type (e.g., when the signature type classification model is a multi-classifier model).

To train the signature type classification model (and/or the component models thereof), the signatures included in the form documents of the training set may need to be extracted. However, the form documents may not have been signed in a consistent manner. For example, a signature may be located in a variety of relative positions with respect to an expected location of a signature (also referred to herein as an “anchor point”). Additionally, the form documents may not have been digitized in a consistent manner, resulting the image data of the form being skewed. As a result, traditional signature extraction techniques may produce inconsistent results when applied to the full corpus of form documents included in the training set. These inconsistencies may result in the training algorithm producing a classifier that is less accurate at classifying the signature type than if the extracted signature data is consistently positioned and/or aligned in the training set.

As a result, techniques disclosed herein relate to pre-processing the form documents included in the training set to ensure that the training data used to train the signature type classification model results in a more accurate classification model than conventionally possible. This may enable greater confidence in the output of the signature type classification model, thereby reducing the amount of manual review needed to validate the performance of the signature classification model when applied to new forms documents. As a result, both the underlying signature type classification model and the processes in which the signature type classification model is integrated are improved with respect to conventional techniques that do not implement the disclosed pre-processing techniques.

### Exemplary Form Analysis Environment

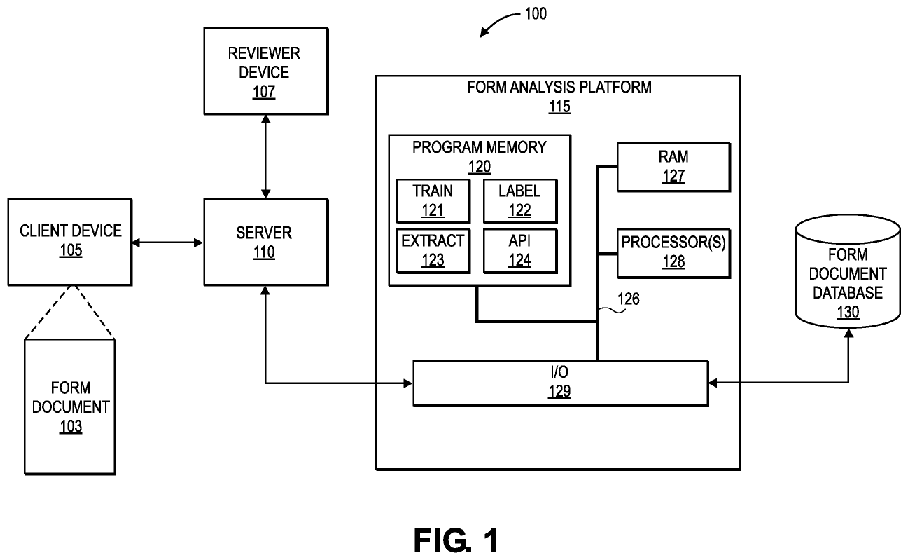

FIG. 1 illustrates a block diagram of an exemplary form analysis environment 100 in which the techniques disclosed herein may be implemented. The form analysis environment 100 includes a form analysis platform 115. In some embodiments, the form analysis platform 115 is operated by a processor of form documents, such as an insurance company, a governmental and/or regulatory agency, a bank and/or other type of financial institution, and so on. It should be appreciated that while the instant disclosure generally refers to “form analysis,” the techniques described herein may be applied to a signature included in any type of document.

As illustrated, the form analysis platform 115 may include one or more processors 128 configured to execute instructions that form the various applications, modules, and other components of the form analysis platform 115 described herein. In cloud computing embodiments, the processors 128 may be physically located in different hardware entities (e.g., servers) while still being logically connected to execute the various tasks described herein. The processors 128 may include central processing units (CPUs), graphics processing units (GPUs), application-specific integrated circuits (ASICS), and/or any other types of computer processors. While the disclosure may generally refer to the processors 128 executing the various tasks described herein, particular tasks may be better suited to one type of processor. For example, the repetitive analysis associated with some operations described herein (e.g., the training routines) may be more efficiently executed by GPUs than CPUs. Accordingly, in embodiments that include multiple types of processors, the form analysis platform 115 may utilize a particular type of processor to execute instructions that are more efficiently executed by the particular type of processor.

The form analysis platform 115 may also include a program memory 120, a random-access memory (RAM) 127, and an input/output (I/O) circuit 129, all of which may be interconnected via an address/data bus 126. It should be appreciated the memory of the form analysis platform 115 may include multiple RAMs 127 and multiple program memories 120 implemented as any type of memory, such as semiconductor memory, magnetically readable memory, or optically readable memory, for example. Similarly, although the I/O circuit 129 is shown as a single block, it should be appreciated that the I/O circuit 129 may include a number of different types of I/O circuits. For example, the I/O block 129 may include one or more transceiver circuits to facilitate communications with other computing components and/or directly with data sources.

The program memory 120 may store any number of applications, routines, tools, or other collections of computer-readable instructions that support the analytics techniques described herein. For example, the program memory 120 may include a training application 121 configured to train an signature type classifier for determining a signature type, a labeling application 122 configured to input a form document into the trained signature classifier to obtain an signature type determination, a signature extraction application 123 configured to extract and/or pre-process a form document and/or a signature included therein, and/or an application programming interface (API) application 124 via which other computing devices, such as a server 110, may invoke the training application 121, the labeling application 122, and/or the extraction application 123. Of course, other applications that leverage the disclosed pre-processing techniques may be stored at the program memory 120.

As illustrated, the form analysis platform 115 may be connected to a form document database 130 that at which a plurality of historical form documents is maintained. It should be appreciated that while the term “database” is used in reference to the database 130, the database 130 may be any type of data storage system. For example, the database 130 may be a local storage system of customer environment hosted by a cloud computing provider. In some embodiments, the form document database 130 may store a plurality of historical form documents of a particular type that have been processed by a processor of form documents. In some embodiments, the historical form documents may be form documents that have been reviewed for acceptability using conventional, manual techniques. In some embodiments, the signature type for the signatures included in form documents are maintained in a signature vector. The signature vector may assign a particular signature entry included in the form documents to a particular index. In each index, the signature vector may include information describing the signature, such as a signature type, image data representative of the signature, an acceptability rule for the signature, and so on). The data maintained in the form document data base 130 may be considered training data for the signature classification model trained by the training application 121.

As it is generally used herein, the term “acceptability rule” refers to a requirement for acceptability associated with a signature. One type of acceptability rule may relate to the signature type (e.g., a rule that only wet ink or DocuSign signatures are permitted). Another type of acceptability rule may relate to the requirement of a presence of a signature (e.g., a rule that a signature is only required if a particular checkbox is marked).

Additionally, the form analysis platform 115 may be communicatively coupled to a server 110 at which a form processing pipeline is implemented. For example, the form analytics platform 115 and the server 110 may be communicatively coupled via one or more wired or wireless networks that facilitate any type of data communication via any current or future-developed standard or technology (e.g., GSM, CDMA, TDMA, WCDMA, LTE, NR, 6G, EDGE, OFDM, GPRS, EV-DO, UWB, IEEE 802 including Ethernet and Wi-Fi, WiMAX, Bluetooth, and others). It should be appreciated that while FIG. 1 depicts the server 110 and the form analysis platform 115 as separate entities, in alternate embodiments, the functionality of the server 110 and the form analysis platform 115 are implemented at the same computing entity (e.g., either one of the server 110 and the form analysis platform 115).

As part of implementing a form processing pipeline, the server 110 may be configured to invoke the functionality of the form analytics platform 115. For example, the server 110 may generate one or more instructions in accordance with a public API supported by the API application 124 and transmit the generated instruction to the form analytics platform 115 for processing thereat.

In one example, the server 110 may generate and transmit an instruction for the form analysis platform 115 to train a signature type classifier for determining the signature type. In this example, the API application 124 may detect the instruction from the server 110 and invoke the training application 121 to train the signature classifier. In response, the training application 121 may identify a plurality of historical form documents and their corresponding training data maintained at the form document database 130. The training application 121 may then invoke the extraction application 123 to extract and pre-process the signature data from the forms included in the form document database 130.

Using the extracted and pre-processed set of signatures, the training application 121 may then train a signature type classifier to output a classification decision on a signature type. For example, the signature classifier may be a classification model, such as a CNN, a logistic regression model, a naive Bayes model, a support vector machine (SVM) model, and so on. The training application 121 may store the trained model data at the form analytics platform 115.

After the signature type classification model is trained, the form analysis platform 115 may integrate the signature classification model into the form acceptability pipeline. In certain scenarios, the server 110 may generate and transmit an instruction for the form analysis platform 115 to determine acceptability of an input form document. To this end, the server 110 may be commutatively coupled with a client device 105, such as a mobile phone, a laptop computer, a tablet, a smart wearable device (e.g., smart glasses, a smart watch), a home personal assistance device, or any other electronic device that is normally used to access internet-based content. For example, the client device 105 may be communicatively coupled to the server 110 via one or more wired or wireless networks that facilitate any type of data communication via any current or future-developed standard or technology (e.g., GSM, CDMA, TDMA, WCDMA, LTE, NR, 6G, EDGE, OFDM, GPRS, EV-DO, UWB, IEEE 802 including Ethernet and Wi-Fi, WiMAX, Bluetooth, and others).

Accordingly, the user of the client device 105 may interact with the client device 105 to submit a filled-out form document 103 to the server 110. For example, the server 110 may support a web interface and/or a client application that executes on the client device and via which a user can upload the form document 103. Upon receiving the form document 103, the server 110 may generate an instruction formatted in accordance with the public API supported by the API application 124. More particularly, the server 110 may generate and transmit an instruction configured to cause the form analysis platform 115 to input the form document 103 into a form acceptability pipeline that includes the trained signature type classification model.

Upon receiving the instruction, API application 124 may invoke the labeling application 122. For example, the instruction may indicate a location at which a copy of the form document 103 may be obtained. In response, the API application 124 may obtain the copy of the form document 103 and extract the signature from the form document 103 using the extraction application 123. As a result, the signatures included in the form 103 may be extracted and pre-processed in a similar manner as the signatures included in the form documents in the form document database 130. The form analysis platform 115 may then cause the labeling application 122 to input the extracted and pre-processed signatures included in the form document 103 into the trained signature type classifier. In response, the trained signature type classification model may output a signature classification label for the input signature(s). The form analysis platform 115 may then generate a signature vector for the form document 103 that includes the signature classification labels and apply the acceptability rules associated with the corresponding form document type to determine the acceptability of the form document 103. The API 124 may then return the acceptability decision to the server 110. In some embodiments, the form analysis platform 115 may also store the copy of the form document 103, the extracted signatures, and/or the applied signature classification label(s) at the form document database 130.

According to certain aspects, performance of the trained signature type classifier may be evaluated to detect a need to re-train the signature classifier. Accordingly, the server 110 may also be communicatively coupled to a reviewer device 107. To this end, the reviewer device 107 may be a mobile phone, a laptop computer, a tablet, a smart wearable device (e.g., smart glasses, a smart watch), a home personal assistance device, or any other electronic device. In some embodiments, the reviewer device 107 may be the same device as the client device 105. The reviewer device 107 may be configured to execute a signature review application via which a reviewer may provide review decisions regarding the signature classifications applied to extracted signatures.

The server 110 may continue to present classified signatures to the reviewer device 107 until a sufficient number of review decisions is reached. The server 110 may then compare the review decisions from the reviewer device 107 to the signature type classification labels applied by the signature type classifier of the labeling application 122. If the review decisions do not align with the signature classification labels, the server 110 may re-train the signature type classifier using the review decisions as the re-training data set. That is, the server 110 may generate an instruction in accordance with the API application 124 such that the form analysis platform 115 executes the training application 121 to re-train the signature type classification model of the labeling application 122 using the review decisions provided by the reviewer device 107.

### Exemplary Extraction and Pre-Processing of Signature Data

According to certain aspects, the extraction application 123 may apply different (and/or multiple) techniques to extract the signature data from a form document (such as the form documents in the form document database 130 or the form document 103 of FIG. 1). If the form document is of a standardized form document type associated with a priori knowledge of expected signature locations, the extraction application 123 may associate the standardized form document type with anchor points and define boundary boxes based upon the position of the anchor point.

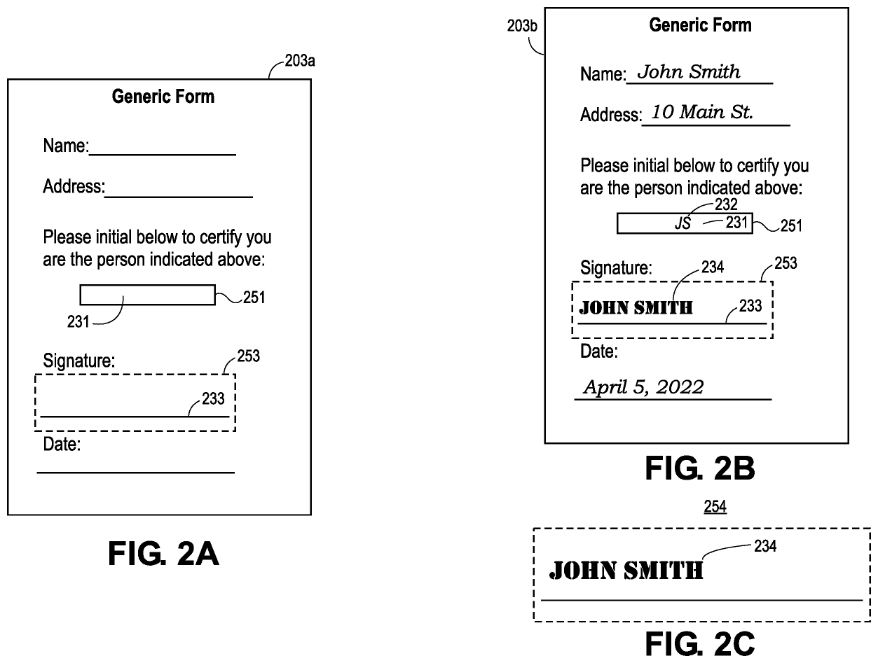

With reference to FIGS. 2A-2C, illustrated is an exemplary process for extracting signature data using anchor point techniques. Starting with FIG. 2A, illustrated is an example form document template 203a. As illustrated, the example form document template 203a include two fields which are required for acceptance, the initials field 231 and the signature field 233. Accordingly, the extraction application 123 may be configured to define anchor points associated with the fields 231, 233. For example, for the initials field 231, the anchor point may correspond to the lower left corner of the corresponding initials box. As another example, the anchor point for the signature field 233 may be a left edge of the corresponding signature line. The extraction application 123 may then associate the form document type with position data associated with the anchor points. For example, the position data may indicate a position of the anchor point as a measure of distance and/or with reference to one or more edges of the form document.

The extraction application 123 may also associate each anchor point with a boundary box defining a region in which the signature is expected to be located. For the initials field 231, the boundary box 251 may be defined to align with a box included in the form document template 203a. For the signature field 233, the boundary box 253 may be defined as indicated by the illustrated dotted lines to incorporate the portion of the form document template 203a proximate to the anchor point. Accordingly, when an image of a form document is input into the extraction application 123, the extraction application 123 may extract the image data from within the boundary boxes 251, 253 as the image data representative of the signature.

Turning to FIG. 2B, illustrated is an exemplary form document 203b on which the extraction application 123 is executing. As illustrated, a user applied their initials to the initials field 231 and their signature to the signature field 233. To initiate the extraction process, the extraction application 123 may first be configured to identify the form document type of the form document 203b. In some embodiments, the form document type is an input parameter to the extraction application 123. Additionally or alternatively, the extraction application 123 may determine the form document type by performing optical character recognition (OCR) techniques on the form document 203b to identify form document type information (e.g., a form title, a form number, etc.). In response to determining the form document type, the extraction application 123 may then obtain the anchor point and corresponding boundary box data associated with the form document type (e.g., the boundary boxes described with respect to the form document template 203a of FIG. 2A) to identify a position of signature data in the form document. The extraction application 123 may then extract the image data within the boundary boxes to generate a signature vector for the form document 203b.

With simultaneous reference to FIG. 2C, illustrated is the identified signature data 254 for the signature 234 associated with the signature field 233 of the form document 203b. In some embodiments, the extraction application 123 may include the identified signature data 254 in the signature vector at an index assigned to the signature field 233. The form analysis platform 115 may then use the generated signature vector to train a signature type classifier and/or to determine a signature type for the signature 234.

It should be appreciated that when the anchor point techniques are applied, the signature data is naively identified, which may result in the signature being inconsistently positioned in the signature data upon extraction. As described above, this inconsistency in positioning may decrease the accuracy of the trained signature type classifier and/or the ability of the signature type classifier to properly assess an input signature.

As another signature extraction technique, the extraction application 123 may invoke an API of a text extraction library to generate the signature vector. According to certain aspects, the text extraction library may be provided by a cloud computing provider at which the form document platform 115 is hosted (e.g., Amazon Textract, Microsoft Computer Vision, Google Direct Text, etc.). This technique may be particularly suitable when a priori knowledge of the form document layout is not available.

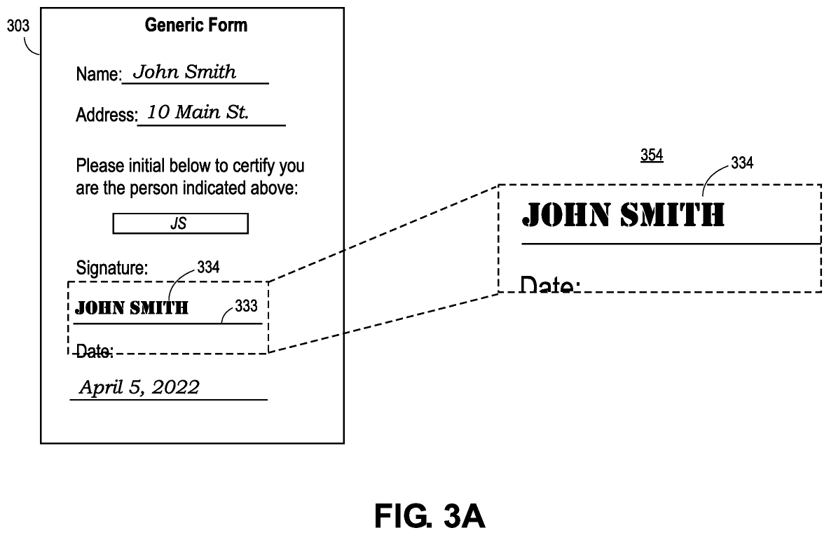

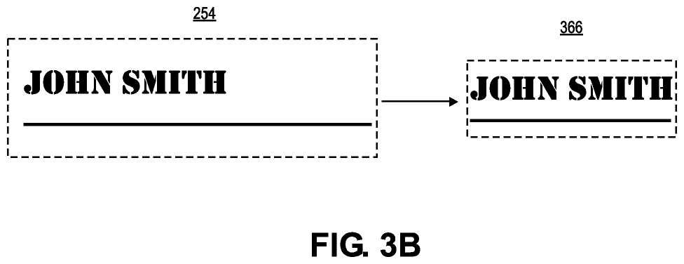

Turning to FIG. 3A, illustrated is an example process for extracting signatures from the form document 303 using the text extraction library. As illustrated, the text extraction library may be configured to output the signature data 354 that includes the signature 334 included in the signature field 334. In response to obtaining the signature data 354, the extraction application 123 may then include the signature data 354 in the signature vector at an index assigned to the signature field 333.

It should be appreciated that when the text extraction library is used to extract the signatures in a form document, the text extraction library may incorrectly identify stray markings or other features of a form document as being representative of a signature. Accordingly, if the non-signature data is used to train a signature type classifier, the inaccurate training data may decrease the accuracy of the resultant trained classifier. Additionally, if the text extraction library extracts additional image data not corresponding to a signature, then automated techniques that rely on signature data being assigned a particular index in a signature vector may not operate correctly. Accordingly, the extraction application 123 may be configured to analyze the output image data to confirm that each of the outputs corresponds to a signature field in the form document 303 and discard the outputs that do not.

In some embodiments, the extraction application 123 may combine both the anchor point techniques and the text extraction library techniques to overcome the above-described drawbacks associated with the use of either technique individually. Turning to FIG. 3B, illustrated is an example process for extracting signatures using both the anchor point techniques and the text extraction library techniques.

To begin, the extraction application 123 may first apply the anchor point techniques described with respect to FIGS. 2A-2C to generate a signature vector that includes the extracted signatured data 254. The extraction application 123 may then input the signature data from the signature vector into the text extraction application. In response, the text extraction library may produce signature data 366 that is a subset of the signature data 254. As a result, there is improved consistency in the position of the signature in the extracted signature data as the extraction application 123 executes on the plurality of form documents in the database 130 and/or on input form documents 103.

According to certain aspects, the form documents included in the form document database 130 and/or submitted as the form document 103 may be inconsistently aligned. Said another way, any given form document may be skewed. However, the angle of the signature may have influence on which type of signature is assigned by a signature classifier. Accordingly, having signatures in the training data having varying amounts of skew may result in a signature type classifier that is less able to rely upon the angle of the signature when classifying signature types, and thus result in a less accurate signature type classifier.

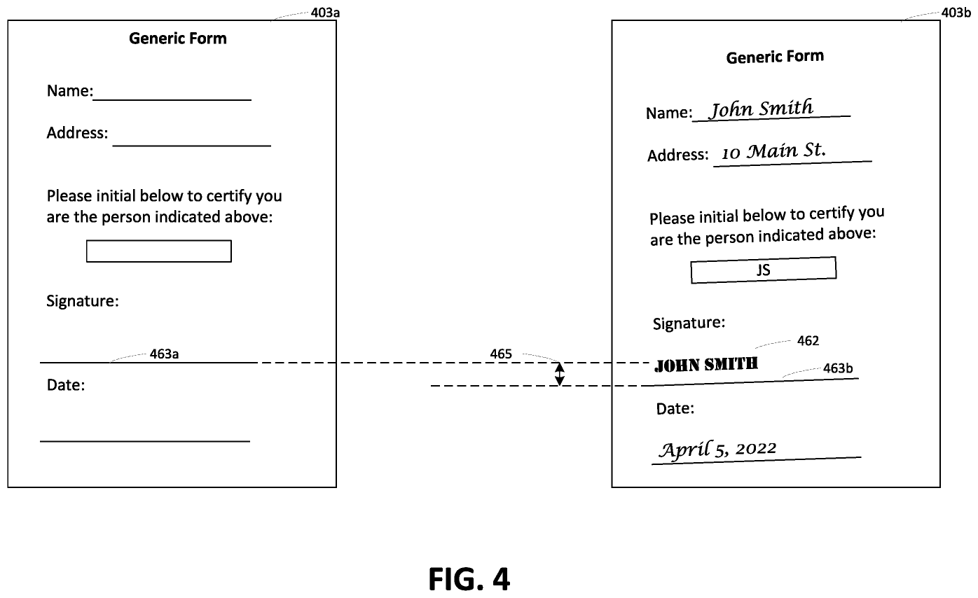

With simultaneous reference to FIG. 4, illustrated is an example process for pre-processing a form document to detect skew. As described above, extraction application 123 may include a form document template 403a (such as the template 203a of FIG. 2A) that includes an anchor point 463a. It should be appreciated that while the anchor point 463a is associated with a signature field, other types of anchor points may be utilized to detect the skew.

When a form document 403b (such as the form documents 103, 203b, and 303) is input into the extraction application 123, the extraction application 123 analyze the form document 403b to determine an amount of skew. To this end, the extraction application 123 may identify a position of the anchor point 463b in the form document 403b. The extraction application 123 may then determine a displacement from an expected position of the anchor point 463b in the absence of skew. The displacement may include a vertical displacement component 465 and/or a horizontal displacement component (not depicted). The extraction application 123 may then generate a skew vector based on the displacement components for use when correcting the skew using a known skew correction algorithm.

In some embodiments, the extraction application 123 corrects the skew in the form document 403b prior to extracting the signatures therein. In these embodiments, the extraction application 123 may correct the skew in the entire form document 403b. In other embodiments, the extraction application 123 may instead apply the skew correction algorithm to the extracted signature data.

In still other embodiments, the extraction application 123 may skew a boundary box associated with anchor points of the form document template in correspondence with the skew angle. Because the skew of the boundary box and the underlying image data are aligned, the extraction application 123 may be able to correct for the skew by rotating the extracted image data.

### Exemplary Pre-Processing of Signature Data

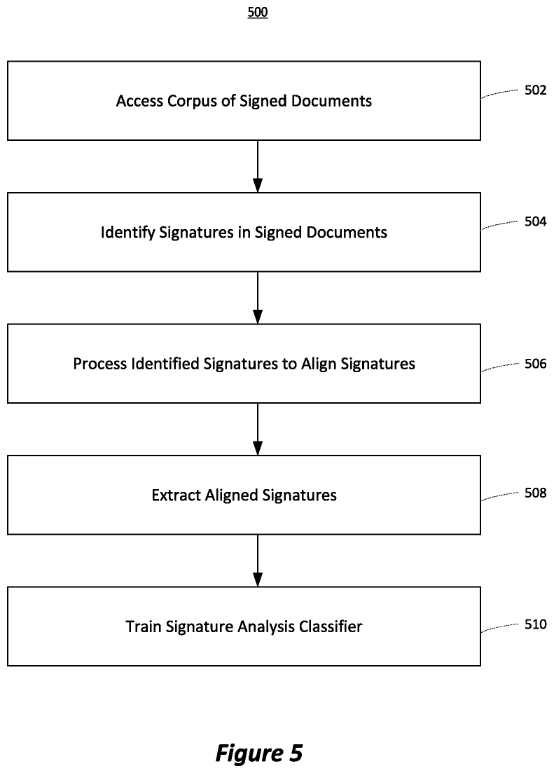

FIG. 5 illustrates a block diagram of an exemplary computer-implemented method 400 for pre-processing signature data. The method 500 may be performed by one or more processors that implement a form analysis platform (such as the form analysis platform 115 of FIG. 1).

The method 500 may begin at block 502 when the form analysis platform accesses a corpus of signed documents (such as a corpus maintained in the form document database 130 of FIG. 1).

At block 504, the form analysis platform identifies a portion of image data in a signed document that represents a signature.

In some embodiments, the form analysis platform may analyze the signed document to identify an anchor point associated with a signature field, and based upon a position of the anchor point, define a boundary box associated with the signature field. In these embodiments, the form analysis platform may be further configured to invoke an application programming interface (API) call using the boundary box as an input. For example, the API call may be provided as part of a text extraction library and configured to provide image data that represents a signature detected within the boundary box as an output.

In other embodiments, the form analysis platform invokes the API call using a document from the corpus of documents as an input document. The API call may be configured to provide image data that represents one or more signatures detected within the input document as an output. In these embodiments, the form analysis platform may be configured to analyze the outputs of the API call to determine whether the outputs correspond to signature fields, and discard outputs of the API call that do not correspond to signature fields.

At block 506, the form analysis platform processes the identified signatures to align the identified image data. In some embodiments, the form analysis platform may detect a skew associated with a document from which the signature was identified, and correct the skew in the image data that represents the identified image data. In these embodiments, the form analysis platform may detect the skew by detecting an offset between a position of an anchor point associated with a document type for the document and a detected position of the anchor point within the document. Additionally or alternatively, invoking the API call using the image data from the defined boundary boxes may be considered processing the identified signatures.

At block 508, the form analysis platform extracts the aligned signatures. In some embodiments, the form analysis platform may correct the skew prior to extracting the signatures. Accordingly, in these embodiments, the form analysis platform may be configured to (1) detect a skew associated with a document in the corpus of documents, (2) correct the skew in the document, and (3) extract the signature from the corrected document.

At block 510, the form analysis platform is configured to train a signature type classifier using the processed and extracted signatures. For example, in some embodiments, the signature analysis classifier is configured to detect handwritten signatures. The method 500 may include additional, fewer, or alternate actions, including those discussed elsewhere herein

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing.” “calculating.” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method for pre-processing signature data, the method comprising:
accessing, via one or more processors, a corpus of signed documents;
identifying a portion of image data in a signed document that represents a signature;
processing, via the one or more processors, the identified signatures to align the corresponding image data;
extracting, via the one or more processors, the aligned signatures; and
training, via the one or more processors, a signature type classifier using the extracted signatures.

2. The computer-implemented method of claim 1, wherein identifying the portion of the image data that represents the signature comprises:
analyzing, via the one or more processors, the signed document to identify an anchor point associated with a signature field; and
based upon a position of the anchor point, defining, via the one or more processors, a boundary box associated with the signature field.

3. The computer-implemented method of claim 2, wherein processing the identified signatures comprises:
invoking, via the one or more processors, an application programming interface (API) call using the boundary box as an input, wherein the API call is configured to provide image data that represents a signature detected within the input boundary box as an output.

4. The computer-implemented method of claim 1, wherein identifying the portion of the image data that represents the signature comprises:
invoking, via the one or more processors, an application programming interface (API) call using a document from the corpus of documents as an input document, wherein the API call is configured to provide image data that represents one or more signatures detected within the input document as an output.

5. The computer-implemented method of claim 4, further comprising:
analyzing, via the one or more processors, the outputs of the API call to determine whether the outputs correspond to signature fields; and
discarding, via the one or more processors, outputs of the API call that do not correspond to signature fields.

6. The computer-implemented method of claim 1, wherein processing the identified signatures comprises:
detecting, via the one or more processors, a skew associated with a document from which the signature was identified; and
correcting, via the one or more processors, the skew in the image data that represents the identified image data.

7. The computer-implemented method of claim 6, wherein detecting the skew comprises:
detecting, via the one or more processors, an offset between a position of an anchor point associated with a document type for the document and a detected position of the anchor point within the document.

8. The computer-implemented method of claim 1, wherein extracting the signatures comprises:
detecting, via the one or more processors, a skew associated with a document in the corpus of documents;
correcting, via the one or more processors, the skew in the document; and
extracting, via the one or more processors, the signature from the corrected document.

9. The computer-implemented method of claim 1, wherein the signature type classifier is configured to detect handwritten signatures.

10. A computer system for pre-processing signature data, the computer system comprising:
one or more processors; and
one or more non-transitory memories storing processor-executable instructions that, when executed by the one or more processors, cause the system to:
access a corpus of signed documents;
identify a portion of image data in a signed document that represents a signature;
process the identified signatures to align the corresponding image data;
extract the aligned signatures; and
train a signature type classifier using the extracted signatures.

11. The computer system of claim 10, wherein to identify the portion of the image data that represents the signature, the instructions, when executed, cause the system to:
analyze the signed document to identify an anchor point associated with a signature field; and
based upon a position of the anchor point, define a boundary box associated with the signature field.

12. The computer system of claim 11, wherein to process the identified signatures, the instructions, when executed, cause the system to:
invoke an application programming interface (API) call using the boundary box as an input, wherein the API call is configured to provide image data that represents a signature detected within the input boundary box as an output.

13. The computer system of claim 10, wherein to identify the portion of the image data that represents the signature, the instructions, when executed, cause the system to:
invoke an application programming interface (API) call using a document from the corpus of documents as an input document, wherein the API call is configured to provide image data that represents one or more signatures detected within the input document as an output.

14. The computer system of claim 13, wherein the instructions, when executed, cause the system to:
analyze the outputs of the API call to determine whether the outputs correspond to signature fields; and
discard outputs of the API call that do not correspond to signature fields.

15. The computer system of claim 10, wherein to process the identified signatures, the instructions, when executed, cause the system to:
detect a skew associated with a document from which the signature was identified; and
correct the skew in the image data that represents the identified image data.

16. The computer system of claim 15, wherein to detect the skew, the instructions, when executed, cause the system to:
detect an offset between a position of an anchor point associated with a document type for the document and a detected position of the anchor point within the document.

17. The computer system of claim 10, wherein to extract the signatures, the instructions, when executed, cause the system to:
detect a skew associated with a document in the corpus of documents;
correct the skew in the document; and
extract the signature from the corrected document.

18. The computer system of claim 10, wherein the signature type classifier is configured to detect handwritten signatures.

19. A non-transitory computer readable storage medium storing computer-executable instructions that, when executed by one or more processors, cause the one or more processors to:
access a corpus of signed documents;
identify a portion of image data in a signed document that represents a signature;
process the identified signatures to align the corresponding image data;
extract the aligned signatures; and
train a signature type classifier using the extracted signatures.

20. The non-transitory computer readable storage medium of claim 19, wherein the signature type classifier is configured to detect handwritten signatures.
